(19) United States
(12) Patent Application Publication
(10) Pub. No.: US 2026/0337413 A1
(43) Pub. Date: Oct. 29, 2026

(54) THERMALLY CONDUCTIVE SILICONE POTTING COMPOSITIONS, AND ARTICLES AND ASSEMBLIES THEREFROM

(71) Applicant: Henkel AG & Co. KGaA, Düsseldorf (DE)

(72) Inventors: Shunquan Yu, Shanghai (CN); Ting Zhang, Shanghai (CN); Xueyu Qiu, Shanghai (CN)

(21) Appl. No.: 19/703,520

(22) Filed: Jun. 10, 2026

Related U.S. Application Data
(63) Continuation of application No. PCT/CN2023/139699, filed on Dec. 19, 2023.

(51) Int. Cl. C08L 83/04; C08K 3/22; C08K 7/18; H01M 10/653

(52) U.S. Cl. CPC C08L 83/04; C08K 3/22; C08K 7/18; C08K 2003/2227; C08K 2201/005; C08L 2203/206; C08L 2205/025; C08L 2205/03; H01M 10/653

(57) ABSTRACT

A thermal-conductive silicone potting composition and articles potted therewith, the composition comprising a component (A) comprising: a vinyl organopolysiloxane, a catalyst, a filler combination, an optional pigment; a component (B) comprising an optional vinyl organopolysiloxane, a hydrogenated organopolysiloxane, an optional inhibitor, a filler combination, wherein the filler combination includes: a non-spherical alumina having an average particle size of less than 3 μm, an alumina having an average particle size of 5 μm to 15 μm, and a spherical alumina having an average particle size of 30 μm to 70 μm, wherein the thermal-conductive silicone potting compositions show high thermal conductivity, high flowability, low viscosity and good storage stability.

### TECHNICAL FIELD

The present disclosure relates to a thermally conductive silicone potting composition. In particular, the present invention relates to a two-component thermally conductive silicone potting composition.

### BACKGROUND OF THE INVENTION

With the rapid development of new energy vehicles (NEVs), thermal interface materials are gaining wide attentions to quickly transfer heat generated by the battery systems to reduce safety accidents or electrical damage. Silicone compositions are currently widely used for device colling owing to their high-temperature resistance, corrosion resistance, elasticity, fire retardant property and good flexibility. Among these thermal conductive silicone compositions, several systems such as gap fillers, pads, greases are well developed to meet different application requirements. Under specific conditions such as E-mobility power conversion including inverter, converter and on-board-charger, electronic components like circuit boards and semiconductors need to be encapsulated from heat, contamination, vibrations to ensure long term performance. Thermal potting or encapsulant with low viscosity and high flowability can infiltrate into the small devices and achieve promising thermal conductive performance. Silicone-based thermal conductive potting compositions could protect critical electronic devices and are essential in high-temperature applications.

Potting is the process of partially or completely filling or embedding an enclosure with a potting composition. A potting composition configured to form the potting compound may have sufficient flowability before curing to settle at a level height around the component being potted or encapsulated, particularly if the component being potted or encapsulated has many small voids.

Current thermal conductive silicone potting compositions generally exhibit high thermal conductivity by increasing filler loading amount and thus give rise to poor flowability. It is hard to achieve high thermal conductivity and high flowability simultaneously. Especially for silicone potting composition with high thermal conductivity of greater than 2.88 W/m·k, or greater than 3.0 W/m·k, high thermal conductivity and high flowability are conflicting with each other.

US 2022/0025181 A1 discloses a thermally conductive silicone potting composition, of which the viscosity is in the range of 3 to 20 Pas and the thermal conductivity is in the range of 1.7 to 2.7 W/mk. Although the viscosity is quite low, the thermal conductivity may not meet the requirement of some applications.

CN 103214853 B discloses a heat-conductive silicone composition with high thermal conductivity of almost 3.0 W/m·k. However, large amounts of fillers are added and give rise to high viscosity of over 500 Pas. Such heat-conductive silicone composition with high viscosity is not suitable for potting or encapsulant.

Therefore, there is a need to develop a silicone composition with high thermal conductivity of approximate to 3.0 W/m·k, for example, 2.88 W/m·k or more, preferably equal to or greater than 3.0 W/m·k, which still exhibits a good flowability.

### SUMMARY OF THE INVENTION

It is therefore the object of the present invention to overcome the above-mentioned drawbacks by providing a thermally conductive silicone potting composition with high flowability, low viscosity, good storage stability and good thermal conductivity.

It has been surprisingly found that thermally conductive silicone potting adhesive prepared from a two-component thermally conductive silicone potting composition comprising at least a vinyl organopolysiloxane, a hydrogenated organopolysiloxane, an optional inhibitor, a catalyst, a filler combination, wherein the filler combination includes a non-spherical alumina having an average particle size of less than 3 μm, an alumina having an average particle size of 5 μm to 15 μm and a spherical alumina having an average particle size of 30 μm to 70 μm, which provides very good balance between high flowability, low viscosity, good storage stability and high thermal conductivity.

According to one aspect, the present invention relates to a thermal-conductive silicone potting composition comprising: a component (A) comprising: a vinyl organopolysiloxane, a catalyst, a filler combination (e), an optional pigment (f), and a component (B) comprising: an optional vinyl organopolysiloxane, a hydrogenated organopolysiloxane, an optional inhibitor, a filler combination (e), wherein the filler combination (e) includes: e1) a non-spherical alumina having an average particle size D₅₀ of less than 3 μm, e2) an alumina having an average particle size D₅₀ of 5 μm to 15 μm, e3) a spherical alumina having an average particle size D₅₀ of 30 μm to 70 μm.

According to another aspect, the present invention also relates to a thermal conductive potting adhesive comprising the thermal-conductive silicone potting composition according to present disclosure. Especially the thermal conductive potting adhesive has a thermal conductivity of equal to or greater than 2.88 W/(m·K) when subjected to ISO 22007-2 2022.

According to still another aspect, the present invention also relates to a use of the thermal-conductive silicone potting composition according to present invention in electronic components.

According to still another aspect, the present invention also relates to an article potted by using the thermal-conductive silicone potting composition according to present disclosure. Especially related to an electronic component comprises such an article.

According to still another aspect, the present invention also relates to a battery module comprising an electric cell and a potting composition according to any one of embodiments 1 to 13, associated with the electric cell.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. For example, reference to “a filler” encompasses embodiments having one, two or more fillers. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, several terms shall be utilized.

The terms “polymer” is used herein consistent with its common usage in chemistry. Polymers are composed of many repeated subunits. The term “polymer” is used to describe the resultant material formed from a polymerization reaction.

As used herein, by “D₅₀ particle size” is meant that the particle size distribution is such that at least 50% of the particles by weight have a particle size diameter of less than the specified value. Unless otherwise stated, that particle size is determined by laser diffraction.

As discussed previously, embodiments of the present disclosure are directed to a two-component thermal-conductive silicone potting composition comprising:
a component (A) comprising:
   (a) a vinyl organopolysiloxane,
   (c) a catalyst,
   (e) a filler combination,
   (f) an optional pigment,
a component (B) comprising:
   (a) an optional vinyl organopolysiloxane,
   (b) a hydrogenated organopolysiloxane,
   (d) an optional inhibitor,
   (e) a filler combination,
   wherein the filler combination (e) includes:
      e1) a non-spherical alumina having an average particle size of less than 3 μm,
      e2) an alumina having an average particle size of 5 μm to 15 μm,
      e3) a spherical alumina having an average particle size of 30 μm to 70 μm.

### Vinyl Organopolysiloxane (a).

The two-component thermally conductive silicone potting composition of the present invention includes vinyl organopolysiloxane to build up the polymer backbone in addition-cured silicones.

The vinyl organopolysiloxane contains two or more vinyl groups bonded to silicon atoms in each molecule and can be either a linear structure or a branched or a cyclic structure. A vinyl organopolysiloxane with linear structure is preferred.

The vinyl organopolysiloxane has a viscosity of 20 cSt to 100 cSt at 25 °C, in particular 20 cSt to 50 cSt. Lower viscosity may give rise to poor storage stability, while higher viscosity may lead to poor flowability.

Examples of vinyl organopolysiloxanes include, for example, [Vi(CH₃)₂SiO_{1/2}]_{0.091}[(CH₃)₂SiO_{2/2}]_{0.909}, [Vi(CH₃)₂SiO_{1/2}]_{0.060}[(CH₃)₂SiO_{2/2}]_{0.940}, [Vi(CH₃)₂SiO_{1/2}]_{0.028}[(CH₃)₂SiO_{2/2}]_{0.972}, [Vi(CH₃)₂SiO_{1/2}]_{0.075}[(CH₃)₂SiO_{2/2}]_{0.425} [SiO_{4/2}]_{0.5} and [Vi(CH₃)₂SiO_{1/2}]_{0.019}[(CH₃)₂SiO_{2/2}]_{0.981}.

Examples of commercially available vinyl organopolysiloxane include VS 50, VS 20, VS 100, VS 200, VQM2050 from AB Specialty Silicone and RH-Vi395 from Zhejiang Runhe Silicone New Materials Co., Ltd.

The vinyl organopolysiloxane is present in an amount of 1 to 9 wt. %, or 2 to 8 wt. %, or 5 to 8 wt. %, or 6 wt. % to 8 wt. %, or 7 wt. %-8 wt. %, based on the total weight of the silicone potting. Less vinyl organopolysiloxane will lead to higher viscosity, while more vinyl organopolysiloxane will give rise to lower thermal conductivity.

In the present invention, the vinyl organopolysiloxane may be a combination of two or more of the above vinyl organopolysiloxanes. And the vinyl organopolysiloxane is present in component (A) or respectively in component (A) and component (B).

### Hydrogenated Organopolysiloxane (b)

The thermally conductive silicone potting composition of the present invention includes hydrogenated organopolysiloxane to be the crosslinker in addition-cured silicones.

Hydrogenated organopolysiloxanes are cross-linking agents containing at least two, preferably three or more than three hydrogen atoms bonded to silicon atoms per molecule. The structure of hydrogenated organopolysiloxanes can be linear, branched, or cyclic.

The hydrogenated organopolysiloxane preferably has a viscosity at 25 °C. of 20 cSt to 100 cSt, more preferably 20 cSt to 50 cSt. Viscosity can be measured with a BM-type rotational viscometer. Lower viscosity may give rise to poor storage stability, while higher viscosity may lead to poor flowability.

Examples of hydrogenated organopolysiloxanes include, for example, [H(CH₃)₂SiO_{1/2}]_{0.117}[(CH₃)₂SiO_{2/2}]_{0.883}, [(CH₃)₃SiO_{1/2}]_{0.017}[H(CH₃)SiO_{2/2}]_{0.069}[(CH₃)₂SiO_{2/2}]_{0.914} and [H(CH₃)₂SiO_{1/2}]_{0.012}[(CH₃)₂SiO_{2/2}]_{0.988}. More preferably, the hydrogenated organopolysiloxane is a combination of [(CH₃) 3SiO_{1/2}]_{0.017}[H(CH₃)SiO_{2/2}]_{0.069}[(CH₃)₂SiO_{2/2}]_{0.914} and [H(CH₃)₂SiO_{1/2}]_{0.012}[(CH₃)₂SiO_{2/2}]_{0.988}, or a combination of [H(CH₃)₂SiO_{1/2}]_{0.117}[(CH₃)₂SiO_{2/2}]_{0.883}, [(CH₃) 3SiO_{1/2}]_{0.017}[H(CH₃)SiO_{2/2}]_{0.069}[(CH₃)₂SiO_{2/2}]_{0.914} and [H(CH₃)₂SiO_{1/2}]_{0.012}[(CH₃)₂SiO_{2/2}]_{0.988.}

The hydrogenated organopolysiloxane can be any known hydrogenated organopolysiloxane. Examples of commercially available hydrogenated organopolysiloxane include RH-H57 from Zhejiang Runhe Silicone New Materials Co., Ltd. And CE 13, XL1B and CE500, all of which are available from AB Specialty Silicone Company. More preferably, the hydrogenated organopolysiloxane is a combination of XL1B and CE500, or a combination of CE 13, XL1B and CE500.

The hydrogenated organopolysiloxane is present in an amount of 1 to 6 wt. %, or 1 to 5 wt. %, or 1.1 to 3 wt. %, or 1.1 wt. % to 2 wt. %, or 1.15 wt. %-1.25 wt. % in component (B), based on the total weight of the 2-component silicone potting composition. Less hydrogenated organopolysiloxane will lead to higher viscosity, while more hydrogenated organopolysiloxane will give rise to lower thermal conductivity.

In some embodiments of the 2-component silicone potting compositions, the content of the vinyl organopolysiloxane and the hydrogenated organopolysiloxane is from 8.4% to 9.3%, or 8.45% to 9.2%, 8.5% to 9.1% by weight, based on the total weight of the thermal-conductive silicone potting composition.

In the present invention, the hydrogenated organopolysiloxane may be a combination of two or more of the above hydrogenated organopolysiloxanes. Preferably, the hydrogenated organopolysiloxane is a combination of two or three of the above hydrogenated organopolysiloxanes.

In the present invention, the weight ratio of component (a) to component (b) is preferably in the range of 10:1 to 1:10, more preferably in the range of 8:1 to 1:3, especially in the range of 7:1 to 1:1, especially 7:1 to 4:1.

### Catalyst (c)

According to the present invention, the two-component thermally conductive silicone potting composition contains a catalyst.

The catalyst of the present invention can be anyone that can catalyze the addition reaction between vinyl organopolysiloxane and hydrogenated organopolysiloxane such as metal complexes including platinum, rhodium, palladium, and so forth.

Examples of commercially available catalysts include, for example: SIP 6832.2, which is 2% Pt in cyclomethylvinylsiloxane available from Gelest Company; Catalyst 172 and Catalyst 512 from Evonik.

The catalyst is present in the 2-component thermally conductive silicone potting composition of the present invention in an amount of 1 to 1000 ppm platinum based on the weight of the total thermally conductive silicone potting composition, preferably based on the weight of the total thermally conductive silicone potting composition 5 to 800 ppm platinum, more preferably 10 to 500 ppm platinum based on the weight of the total thermally conductive silicone potting composition, most preferably 100 to 350 ppm platinum based on the weight of the total 2-component thermally conductive silicone potting composition.

### Inhibitor (d)

According to the present invention, the two-component thermally conductive silicone potting composition comprises an optional inhibitor to control the reaction speed and pot life.

In some embodiments, the inhibitor can be vinyl containing siloxanes, alkynes, alkynols, maleates and so forth.

Examples of commercially available inhibiters include tetravinyltetramethylcyclotetrasiloxane (MVC) from Evonik and 3,5-dimethyl-1-hexyn-3-ol from J&K Scientific Company.

The inhibitor is present in an amount of from 0.001 wt. %-0.01 wt. %, preferably 0.001 wt. %-0.005 wt. % based on the total weight of the silicone potting.

### Filler Combination (e)

According to the present invention, the two-component thermally conductive silicone potting composition comprises a filler combination (e) which comprises:
e1) a non-spherical alumina having an average particle size of less than 3 μm,
e2) an alumina having an average particle size of 5 μm to 15 μm, or 5 μm to 13 μm, or 5 μm to 12 μm,
e3) a spherical alumina having an average particle size of 30 μm to 70 μm,

In the present invention, total content of (e) is 91.0-94.5 wt. %, or 91.4-94.0 wt. %, based on the total weight of the silicone potting. Higher amount of filler will lead to higher viscosity and/or bad flowability, while less filler amount will give rise to lower thermal conductivity.

<Non-Spherical Alumina (e1)>

According to the present invention, the filler combination comprises non-spherical alumina (e1) having an average particle size D₅₀ of less than 3 μm.

The average particle size D₅₀ of the non-spherical alumina (e1) is less than 3 μm, or 0.3-2.9 μm, or 0.4-2.8 μm, or 0.5-2.8 μm, and the shape of the non-spherical alumina (e1) should be non-spherical.

Examples of commercially available non-spherical alumina (e1) include SAO-050E, a non-spherical alumina with a D50=0.8-1.2 μm, from Shandong Sinocera Functional Materials Co., Ltd., NSM-1S and NSM-2S, non-spherical alumina with D50=0.5-0.8 μm and 1.13 μm respectively, from Bestry Performance Materials Co., Ltd., AP-08D and Al-02D, non-spherical alumina with D₅₀=0.8 μm and 2.23 μm respectively, from CMP Tianjin Co., Ltd., TIMal-66, a non-spherical alumina with a D₅₀=1.8 μm, from Alteo and Y2, a non-spherical alumina with a D50=1.8 μm, from Suzhou Ginet New Materials Technology Co., Ltd.

The non-spherical alumina (e1) is present in a total amount of from 10 wt. % to 32 wt. % based on the total weight of the silicone potting. The lower limit of the non-spherical alumina (e1) is 10 wt. %, or 11 wt. %, or 11.5 wt. %, or 15 wt. %, or 20 wt. %; the upper limit of the non-spherical alumina (e1) is 32 wt. %, or 31.5 wt. %, or 28 wt. %, or 25 wt. %.

In some embodiments, the thermal-conductive silicone potting composition further comprises a spherical alumina having an average particle size D₅₀ of less than 3 μm.

In some embodiments, the thermal-conductive silicone potting composition further comprises less than 65%, less than 60%, less than 58%, less than 55%, less than 52% by weight of a spherical alumina (ce1a) having an average particle size D₅₀ of less than 1 μm, based on the total weight of the spherical alumina (ce1a) and the non-spherical alumina (e1).

In some embodiments, the thermal-conductive silicone potting composition further comprises less than 12% by weight, or less than 10% by weight, or less than 7% by weight, or less than 5% by weight, less than 3% by weight, of a spherical alumina (ce1b) having an average particle size D₅₀ of 1-3 μm, based on the total weight of the spherical alumina (ce1b) and the non-spherical alumina (e1).

<Alumina (e2)>

The filler combination of present invention comprises alumina having an average particle size D₅₀ of 5 μm to 15 μm (e2).

The average particle size D50 of (e2) is in the range of 5 μm to 15 μm, or 5 μm to 14 μm, or 5 μm to 13 μm, or 5 μm to 12 μm, for example, 5 μm, 5.5 μm, 6 μm, 7 μm, 8 μm, 10 μm, 11 μm, 12 μm.

In addition, examples of the shape of the alumina (e2) include a spherical shape, a spheroidal shape, a flake shape, a needle shape, and an indeterminate shape.

Examples of commercially available (e2) include BAK5, a spherical alumina with D₅₀=5.2-5.76 μm, from Bestry Performance Materials Co., Ltd., QY10 and Y10, spherical and non-spherical alumina with D₅₀=12 μm, from Suzhou Ginet New Materials Technology Co., Ltd. and SFADW10, a spherical alumina with D₅₀=10 μm, from CMP Tianjin Co., Ltd.

The component (e2) is present in a total amount of from 3 wt. % to 10 wt. % based on the total weight of the silicone potting composition.

<Spherical Alumina (e3)>

The filler combination of present disclosure comprises spherical alumina (e3) having an average particle size D₅₀ of 30 μm to 70 μm (e3).

In some embodiments, the average particle size D₅₀ of the spherical alumina (e3) is in the range of 30 μm to 70 μm, or 40 μm to 70 μm, or 49 μm to 65 μm and the shape of (e3) should be spherical.

Some comparative alumina particles of (e3) are in a spheroidal shape, which is typically elongated, oblong, etc. and may include alumina having an ellipsoid shape, an ovoid shape, a rectangular shape, an oblate spheroid shape, etc.

Examples of commercially available spherical alumina (e3) include QYH40, a spherical alumina with D₅₀=47 μm, from Suzhou Ginet New Materials Technology Co., Ltd., SFADW45 and SFADW70, spherical alumina with D₅₀=50 μm and 69 μm respectively, from CMP Tianjin Co., Ltd.

The component (e3) is present in a total amount of from 50 wt. % to 65 wt. % based on the total weight of the silicone potting.

### Pigment (f),

The pigment (f) is a pigment to distinguish the component A and the component B and can be added optionally.

Examples of commercially available pigment (f) include Bayferrox130M from LANXESS.

The pigment (f) is present in a total amount of from 0.01-0.1 wt. %, preferably 0.01-0.05 wt. % based on the total weight of the 2-component thermal conductive silicone potting composition.

### Optional Additives

The compositions of the present invention will typically further comprise optional additives, which are necessarily minor components, but which can nevertheless impart improved properties to these compositions. The total amount of optional additives in the compositions will preferably be up to 10 parts by weight, and more preferably from 0.1 to 10 parts by weight or from 0.1 to 7.5 parts by weight, of the composition. The desired viscosity of the compositions will typically be determinative of the total amount of optional additives added.

### Preparing Method of the 2-Component Thermal Conductive Silicone Potting Composition

The 2-component thermal conductive silicone potting compositions could be prepared by any suitable process. The silicone potting compositions are formulated by simple mixing all the components of component A and mixing all the components of component B.

No particular restrictions are required to prepare the thermal conductive silicone potting composition, as long as the method complies with a conventional method to prepare a two-component thermal conductive silicone potting composition. A 2-liter planetary mixer (manufactured by PC Laborsystem Co., Ltd.) was used in the present invention to prepare the component A and the component B of the thermal conductive silicone potting.

### Listing of Embodiments

1. A thermal-conductive silicone potting composition comprising:
a component (A) comprising:
   (a) a vinyl organopolysiloxane,
   (c) a catalyst,
   (e) a filler combination,
   (f) an optional pigment,
a component (B) comprising:
   (a) an optional vinyl organopolysiloxane,
   (b) a hydrogenated organopolysiloxane,
   (d) an optional inhibitor,
   (e) a filler combination,
wherein the filler combination (e) includes:
   e1) a non-spherical alumina having an average particle size D₅₀ of less than 3 μm,
   e2) an alumina having an average particle size D₅₀ of 5 μm to 15 μm,
   e3) a spherical alumina having an average particle size D₅₀ of 30 μm to 70 μm.

2. The thermal-conductive silicone potting composition of embodiment 1, wherein the content of the filler combination (e) is from 91.0% to 94.5% by weight based on the total weight of the thermal-conductive silicone potting composition.

3. The thermal-conductive silicone potting composition of any one of preceding embodiments, wherein the non-spherical alumina (e1) has an average particle size D₅₀ of 0.5-2.8 μm.

4. The thermal-conductive silicone potting composition of any one of preceding embodiments, wherein the content of the non-spherical alumina (e1) is from 10% to 32% by weight based on the total weight of the thermal-conductive silicone potting composition.

5. The thermal-conductive silicone potting composition of any one of preceding embodiments, wherein the thermal-conductive silicone potting composition further comprises spherical alumina having an average particle size D₅₀ of less than 3 μm.

6. The thermal-conductive silicone potting composition of any one of preceding embodiments, wherein the thermal-conductive silicone potting composition further comprises less than 65% by weight of a spherical alumina (ce1a) having an average particle size D₅₀ of less than 1 μm, based on the total weight of the spherical alumina (ce1a) and the non-spherical alumina (e1).

7. The thermal-conductive silicone potting composition of any one of preceding embodiments, wherein the thermal-conductive silicone potting composition further comprises less than 12% by weight of a spherical alumina (ce1b) having an average particle size D₅₀ of 1-3 μm, based on the total weight of the spherical alumina (ce1b) and the non-spherical alumina (e1).

8 The thermal-conductive silicone potting composition of any one of preceding embodiments, wherein the alumina (e2) has an average particle size D₅₀ of 5-13 μm, or 5-12 μm.

9. The thermal-conductive silicone potting composition of any one of preceding embodiments, wherein the content of the alumina (e2) is from 3% to 10% by weight based on the total weight of the thermal-conductive silicone potting composition.

10. The thermal-conductive silicone potting composition of any one of preceding embodiments, wherein the spherical alumina (e3) has an average particle size D₅₀ of 40-70 μm.

11. The thermal-conductive silicone potting composition of any one of preceding embodiments, wherein the content of the spherical alumina (e3) is from 50% to 65% by weight based on the total weight of the thermal-conductive silicone potting composition.

12. The thermal-conductive silicone potting composition of any one of preceding embodiments, wherein the content of pigment (f) is from 0.01-0.05% by weight based on the total weight of the thermal-conductive silicone potting composition.

13. The thermal-conductive silicone potting composition of any one of preceding embodiments, wherein the content of the vinyl organopolysiloxane and the hydrogenated organopolysiloxane is from 8.4% to 9.3% by weight based on the total weight of the thermal-conductive silicone potting composition.

14. A thermal conductive potting adhesive comprising the thermal-conductive silicone potting composition according to any one of embodiments 1 to 13.

15. The thermal conductive potting adhesive of embodiment 14, wherein the thermal conductive potting adhesive has a thermal conductivity of equal to or greater than 2.88 W/(m·K) when subjected to ISO 22007-2 2022.

16. Use of the thermal-conductive silicone potting composition according to any one of embodiments 1 to 13 in electronic components.

17. An article potted using the thermal-conductive silicone potting composition according to any one of embodiments 1 to 13.

18. An electronic component comprises an article of embodiment 17.

19. A battery module comprising an electric cell and a potting composition according to any one of embodiments 1 to 13, associated with the electric cell.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Raw Materials

| | Product name | Description/function | Source |
|---|---|---|---|
| (a-1) | Andisil VS 50 | vinyl organopolysiloxane | AB Specialty Silicone Company |
| (a-2) | RH-Vi395 | vinyl organopolysiloxane | Zhejiang Runhe Silicone New |
| | | | Materials Co., Ltd. |
| (b) | RH-H57 | hydrogenated organopolysiloxane | Zhejiang Runhe Silicone New |
| | | | Materials Co., Ltd. |
| (c-1) | Catalyst 172 | Pt Catalyst | Evonik |
| (c-2) | Catalyst 512 | Pt Catalyst | Evonik |
| (d-1) | Inhibitor MVC | Inhibitor | Evonik |
| (d-2) | 3,5-dimethyl-1- | Inhibitor | J&K Scientific Company |
| | hexyn-3-ol | | |
| (e1-1) | SAO-050E | D50 = 0.8-1.2 μm, non-spherical | Shandong Sinocera Functional |
| | | alumina | Materials Co., Ltd. |
| (e1-2) | NSM-1S | D50 = 0.5-0.8 μm, non-spherical | Bestry Performance Materials |
| | | alumina | Co., Ltd. |
| (e1-3) | NSM-2S | D50 = 1.13 | Bestry Performance Materials |
| | | μm, non-spherical | Co., Ltd. |
| | | alumina | |
| (e1-4) | AP-08D | D50 = 0.8 μm, non-spherical | CMP Tianjin Co., Ltd. |
| | | alumina | |
| (cela) | AO-502 | D50 = 0.7 μm (based on particle size | Admatechs Co., Ltd. |
| | | distribution diagram), spherical | |
| | | alumina | |
| (e1-5) | A1-02D | D50 = 2.23 μm, non-spherical | CMP Tianjin Co., Ltd. |
| | | alumina | |
| (e1-6) | TIMal-66 | D50 = 1.8 μm, non-spherical | Alteo |
| | | alumina | |
| (e1-7) | Y2 | D50 = 1.8 μm, non-spherical | Suzhou Ginet New Materials |
| | | alumina | Technology Co., Ltd. |
| (ce1b) | DAW-01 | D50 = 1.9 μm, spherical alumina | Denka Corporation |
| (e2-1) | BAK5 | D50 = 5.2-5.76 μm, spherical | Bestry Performance Materials |
| | | alumina | Co., Ltd. |
| (e2-2) | QY10 | D50 = 12 μm, spherical alumina | Suzhou Ginet New Materials |
| | | | Technology Co., Ltd. |
| (e2-3) | SFADW10 | D50 = 10 μm spherical alumina | CMP Tianjin Co., Ltd. |
| (e2-4) | Y10 | D50 = 12 μm, non-spherical alumina | Suzhou Ginet New Materials |
| | | | Technology Co., Ltd. |
| (h) | SFADW20 | D50 = 21 μm, spherical alumina | CMP Tianjin Co., Ltd. |
| (e3-1) | QYH40 | D50 = 47 μm, spherical alumina | Suzhou Ginet New Materials |
| | | | Technology Co., Ltd. |
| (e3-2) | SFADW45 | D50 = 50 μm, spherical alumina | CMP Tianjin Co., Ltd. |
| (e3-3) | SFADW70 | D50 = 69 μm, spherical alumina | CMP Tianjin Co., Ltd. |
| (i) | YR-40 | D50 = 40 μm, spheroidal alumina | Shanghai Yurui New Material |
| | | | Co., Ltd. |
| (e4) | Bayferrox130M | iron oxide | LANXESS |

* All raw materials are directly used without any special treatment.

### Example 1

### <Preparation of the Thermal Conductive Silicone Potting Composition>

### The First Part (Component A):

4.54 g component (a), 0.01 g component (c), 11.945 g component (e1), 3.18 g component (e2), 30.305 g component (e3) and 0.05 g component (e4) were mixed in the weight parts as shown in the following table. 2-liter planetary mixer (manufactured by PC Laborsystem Co., Ltd.) was used to prepare the first part.

### The Second Part (Component B):

3.3 g component (a), 1.24 g component (b), 0.002 g component (d), 11.945 g component (e1), 3.18 g component (e2) and 30.305 g component (e3) were mixed in the weight parts as shown in the following table. 2-liter planetary mixer (manufactured by PC Laborsystem Co., Ltd.) was used to prepare the second part. The obtained first part and second part were stored separately to test viscosity and storage stability. The two parts were mixed manually to test flowability. The two parts were mixed by Speedmixer DC600 and cured at 85 °C. to test thermal conductivity. Test results are shown in the tables below.

### Example 2-19, and CE1-CE14

The thermal conductive silicone potting compositions of E2 to E19, CE1 to CE14 were prepared in reference to Example 1. More details are listed in below result part.

### Test Methods

### Thermal Conductivity

The first part and the second part were mixed under 1600 rpm for 90 s under vacuum. Then the mixture was cured at 85 °C. for 30 mins. Thermal conductivity of the obtained sample was measured by Hot Disk TPS 3500 according to ISO-22007-2 2022.

Thermal conductivity results are recorded and ranked as follows:
Not pass: the thermal conductivity is less than 2.88 W/m·k;
Pass: the thermal conductivity is equal to or greater than 2.88 W/m·k;
Good: the thermal conductivity is equal to or greater than 3 W/m·k.

### Viscosity

The first part and second part were mixed manually and the obtained mixture was tested at a speed of 10 S⁻¹ at 25 °C by TA DISCOVERY HR-3 according to DIN 53019.

Viscosity results are recorded and ranked as follows:
Not pass: the viscosity is greater than 20 Pa·s;
Pass: the viscosity is equal to or lower than 20 Pa·s;
Good: the viscosity is equal to or lower than 12 Pa·s;
Excellent: the viscosity is equal to or lower than 10 Pa·s.

### Flowability

The first part and second part were mixed manually, and 5 mL of the obtained mixture was dropped by a syringe on a piece of glass. The diameter of the dropped sample was measured after 5 mins.

Flowability refers to the flow ability of liquid, which is related to viscosity, but not exactly the same. Viscosity mainly reflects the interaction force between silica gel molecules, while flowability mainly reflects the degree of deformation and change of silica gel under external force.

Flowability results are recorded and ranked as follows:
Not pass: The diameter of 5 mL sample dropped on a piece of glass is less than 70 mm;
Pass: the diameter of 5 mL sample dropped on a piece of glass is equal to or greater than 70 mm;
Good: the diameter of 5 mL sample dropped on a piece of glass is equal to or greater than 75 mm.
Excellent: the diameter of 5 mL sample dropped on a piece of glass is equal to or greater than 80 mm.

### Storage Stability

The first part and second part were stored separately in 1-liter ion cans at room temperature (25 °C±2 °C). After 3 months, the first part and second part were put in a two-roll mixer to remix with a rotate speed of 300 rpm. The storage stability grade 1-5 demonstrate that the first part and second part could be remixed, without any sedimentation or agglomerations, less than 0.5 h, from 0.5 h to 1 h, from greater than 1 h to 1.5 h, from greater than 1.5 h to 2 h and greater than 2 h, respectively.

Storage stability results are recorded and ranked as follows:
Not pass: grade 4-5;
Pass: grade 3 or less;
Good: grade 2 or less;
Excellent: grade 1.

TABLE 1
Thermal conductive silicone potting compositions of E1-E9.

| Product name | E1 | E2 | E3 | E4 | E5 | E6 | E7 | E8 | E9 |
|---|---|---|---|---|---|---|---|---|---|
| Andisil VS 50 | 7.84 | 7.84 | 7.84 | 7.84 | 7.84 | 7.84 | 7.84 | 7.83 | 7.84 |
| RH-H57 | 1.24 | 1.24 | 1.24 | 1.24 | 1.24 | 1.24 | 1.24 | 1.24 | 1.24 |
| Catalyst 172 | 0.01 | 0.01 | | | | 0.01 | 0.01 | 0.017 | 0.01 |
| Catalyst 512 | | | 0.01 | 0.01 | 0.01 | | | | |
| Inhibitor MVC | 0.002 | 0.002 | 0.002 | 0.002 | 0.002 | 0.002 | 0.002 | 0.005 | 0.002 |
| SAO-050E | | 1.51 | 4.54 | 3.03 | | | | | 23.89 |
| NSM-1S | 3.03 | | | | | | 3.03 | | |
| NSM-2S | | | | | 3.03 | 4.55 | | | |
| A1-02D | 20.86 | | 19.35 | 20.91 | 20.86 | 26.92 | 20.89 | 23.89 | |
| TIMal-66 | | 22.38 | | | | | | | |
| QY10 | 6.36 | 6.36 | | 3.03 | 9.09 | | 6.36 | 6.36 | 6.36 |
| SFADW10 | | | 6.36 | | | 9.09 | | | |
| QYH40 | 60.61 | 60.61 | 60.61 | | 57.88 | | | 60.61 | 60.61 |
| SFADW45 | | | | 63.94 | | 50.3 | | | |
| SFADW70 | | | | | | | 60.61 | | |
| Bayferrox130M | 0.05 | 0.05 | 0.05 | | 0.05 | 0.05 | 0.02 | 0.05 | 0.05 |

TABLE 2
Testing results of the thermal conductive silicone potting compositions El-E9.

| Test item | E1 | E2 | E3 | E4 | E5 | E6 | E7 | E8 | E9 |
|---|---|---|---|---|---|---|---|---|---|
| Thermal | 3.07 | 3 | 3 | 2.99 | 2.93 | 3.06 | 3.08 | 2.91 | 2.95 |
| Conductivity | | | | | | | | | |
| (W/m · k) | | | | | | | | | |
| Viscosity (Pa · s) | 10.81 | 11.37 | 9.05 | 10.24 | 10.25 | 8.95 | 10.72 | 10.67 | 11.23 |
| Flowability (mm) | 79 | 77 | 76 | 80 | 73 | 79 | 81 | 78 | 75 |
| Storage Stability | 3 | 2 | 1 | 2 | 2 | 1 | 3 | 2 | 2 |

TABLE 3
Thermal conductive silicone potting compositions of E10-E19.

| Product name | E10 | E11 | E12 | E13 | E14 | E15 | E16 | E17 | E18 | E19 |
|---|---|---|---|---|---|---|---|---|---|---|
| Andisil VS 50 | 7.84 | | | 7.84 | 7.84 | 7.84 | 7.84 | 7.43 | 7.14 | 6.86 |
| RH-Vi395 | | 7.83 | 7.84 | | | | | | | |
| RH-H57 | 1.24 | 1.24 | 1.24 | 1.24 | 1.24 | 1.24 | 1.24 | 1.15 | 1.13 | 1.1 |
| Catalyst 172 | 0.01 | 0.017 | 0.01 | 0.01 | 0.01 | 0.01 | 0.01 | 0.01 | 0.01 | 0.01 |
| Inhibitor MVC | 0.002 | 0.005 | 0.002 | 0.002 | 0.002 | | | 0.002 | 0.002 | 0.002 |
| 3,5-dimethyl-1- | | | | | | 0.002 | 0.002 | | | |
| hexyn-3-ol | | | | | | | | | | |
| NSM-1S | | 3.03 | 3.03 | 3.03 | | | | 3.05 | 3.06 | 3.07 |
| AP-08D | 3.03 | | | | | | | | | |
| AO-502 | | | | | 3.03 | 7.57 | 12.12 | | | |
| A1-02D | 20.91 | | 20.86 | 20.86 | 20.86 | 16.32 | 11.77 | 20.96 | 21.04 | 21.12 |
| Y2 | | 20.86 | | | | | | | | |
| BAK5 | | | | 6.36 | | | | | | |
| QY10 | 6.36 | 6.36 | | | 6.36 | 6.36 | 6.36 | 6.38 | 6.41 | 6.44 |
| Y10 | | | 6.36 | | | | | | | |
| QYH40 | 60.61 | 60.61 | 60.61 | 60.61 | 60.61 | 60.61 | 60.61 | 60.97 | 61.16 | 61.35 |
| Bayferrox130M | | 0.05 | 0.05 | 0.05 | 0.05 | 0.05 | 0.05 | 0.05 | 0.05 | 0.05 |

TABLE 4
Testing results of the thermal conductive silicone potting compositions E10-E19.

| Test item | E10 | E11 | E12 | E13 | E14 | E15 | E16 | E17 | E18 | E19 |
|---|---|---|---|---|---|---|---|---|---|---|
| Thermal | 3.06 | 2.96 | 3 | 3.01 | 2.95 | 2.88 | 2.96 | 3.12 | 3.16 | 3.26 |
| Conductivity | | | | | | | | | | |
| (W/m · k) | | | | | | | | | | |
| Viscosity (Pa · s) | 10.98 | 10.5 | 11.34 | 9.22 | 10.06 | 10.25 | 11.52 | 11.24 | 17.09 | 19.82 |
| Flowability (mm) | 79 | 78 | 78 | 81 | 79 | 86 | 85 | 76 | 72 | 71 |
| Storage Stability | 3 | 3 | 2 | 2 | 2 | 2 | 1 | 3 | 2 | 2 |

TABLE 5
Thermal conductive silicone potting compositions of CE1-CE8.

| Product name | CE1 | CE2 | CE3 | CE4 | CE5 | CE6 | CE7 | CE8 |
|---|---|---|---|---|---|---|---|---|
| Andisil VS 50 | 7.84 | 7.84 | 7.84 | 7.84 | 7.84 | 7.84 | 7.84 | 7.84 |
| RH-H57 | 1.24 | 1.24 | 1.24 | 1.24 | 1.24 | 1.24 | 1.24 | 1.24 |
| Catalyst 172 | 0.01 | 0.01 | 0.01 | 0.01 | 0.01 | 0.01 | 0.01 | 0.01 |
| Inhibitor MVC | 0.002 | 0.002 | 0.002 | 0.002 | 0.002 | 0.002 | 0.002 | 0.002 |
| NSM-1S | | 3.03 | 3.03 | 3.03 | | | 3.03 | 7.57 |
| AO-502 | | | | | 16.32 | 23.89 | | |
| A1-02D | | 20.86 | 20.86 | | 7.57 | | | |
| TIMal-66 | 14.8 | | | | | | | |
| DAW-01 | | | | | | | 20.86 | 16.32 |
| BAK5 | | | | 20.86 | | | | |
| QY10 | 3.03 | 6.36 | 6.36 | 6.36 | 6.36 | 6.36 | 6.36 | 6.36 |
| SFADW20 | | | 60.61 | | | | | |
| QYH40 | 73.03 | | | | 60.61 | 60.61 | 60.61 | 60.61 |
| SFADW45 | | | | 60.61 | | | | |
| YR-40 | | 60.61 | | | | | | |
| Bayferrox130M | 0.05 | 0.05 | 0.05 | 0.05 | 0.05 | 0.05 | 0.05 | 0.05 |

TABLE 6
Testing results of the thermal conductive
silicone potting compositions CE1-CE8.

| Test item | CE1 | CE2 | CE3 | CE4 | CE5 | CE6 | CE7 | CE8 |
|---|---|---|---|---|---|---|---|---|
| Thermal | 2.72 | 3.1 | 2.62 | 2.5 | 2.71 | 2.64 | 2.63 | 2.6 |
| Conductivity | | | | | | | | |
| (W/m · k) | | | | | | | | |
| Viscosity | 21.82 | 18.68 | 8.74 | 7.99 | 19.07 | 29.13 | 7.31 | 7.75 |
| (Pa · s) | | | | | | | | |
| Flowability | 64 | 43 | 70 | 83 | 70 | 53 | 88 | 85 |
| (mm) | | | | | | | | |
| Storage | 2 | 3 | 1 | 1 | 2 | 2 | 3 | 2 |
| Stability | | | | | | | | |

TABLE 7
Thermal conductive silicone potting compositions of CE10-CE14.

| Product name | CE9 | CE10 | CE11 | CE12 | CE13 | CE14 |
|---|---|---|---|---|---|---|
| Andisil VS 50 | 7.84 | 7.84 | 7.84 | 8.06 | 8.3 | 8.54 |
| RH-H57 | 1.24 | 1.24 | 1.24 | 1.29 | 1.32 | 1.35 |
| Catalyst 172 | 0.01 | 0.01 | 0.01 | 0.01 | 0.01 | 0.01 |
| Inhibitor MVC | 0.002 | 0.002 | 0.002 | 0.002 | 0.002 | 0.002 |
| NSM-1S | 11.77 | 16.32 | 20.86 | 3.02 | 3.01 | 3 |
| A1-02D | | | | 20.8 | 20.74 | 20.68 |
| DAW-01 | 12.12 | 7.57 | 3.03 | | | |
| QY10 | 6.36 | 6.36 | 6.36 | 6.35 | 6.33 | 6.31 |
| QYH40 | 60.61 | 60.61 | 60.61 | 60.42 | 60.24 | 60.06 |
| Bayferrox130M | 0.05 | 0.05 | 0.05 | 0.05 | 0.05 | 0.05 |

TABLE 8
Testing results of the thermal conductive
silicone potting compositions CE9-CE14.

| Test item | CE9 | CE10 | CE11 | CE12 | CE13 | CE14 |
|---|---|---|---|---|---|---|
| Thermal | 2.65 | 2.72 | 2.8 | 2.81 | 2.74 | 2.7 |
| Conductivity | | | | | | |
| W/(m · K) | | | | | | |
| Viscosity (Pa · s) | 7.63 | 9.51 | 10.96 | 7.7 | 8.33 | 7.47 |
| Flowability (mm) | 85 | 81 | 87 | 86 | 91 | 93 |
| Storage Stability | 1 | 1 | 2 | 2 | 2 | 3 |

In Examples 1 to 19, the thermal conductive silicone potting compositions were prepared according to the formulations provided by the present invention. It can be seen that when the contents of the claimed components of the present invention are within certain ranges, component (a), component (b) can act synergistically with filler combination (e) that the prepared thermal conductive silicone potting compositions show high thermal conductivity, high flowability, low viscosity and good storage stability. The thermal conductivity is over 2.88 W/m. K, while high flowability is also realized, the diameter of 5 mL sample dropped on a piece of glass is larger than 70 mm. Moreover, the first part and the second part both show good storage stability individually after 3 months storage at room temperature (25±2 °C).

It can be seen from CE1, the excess amount of spherical alumina (e3) has negative impact on thermal conductivity, viscosity and flowability.

Compared with E1, CE2 shows worse flowability because the spherical alumina (e3) is replaced by a non-spherical alumina with similar particle size, the composition shows bad viscosity and flowability, indicating that the morphology of the filler spherical alumina (e3) is critical to present invention.

Compared with E1, spherical alumina (e3) is replaced by a smaller sized spherical alumina having a D50 of 21 μm in CE3, the composition shows poor thermal conductivity, which indicates that the particle size of the filler spherical alumina (e3) is also critical to present invention.

CE4 comprise insufficient amount of non-spherical alumina (e1), and excess amount of alumina (e2), especially an alumina (e2) with D50 of 5 μm. The thermal conductivity of composition decreases dramatically, which shows the particle size of fillers, especially the particle of small sized filler, have impact on the thermal conductivity. Subtle differences in particle size of small sized filler will lead to huge different result.

CE5 comprise excess amount of small sized spherical alumina (ce1a), which impact the thermal conductivity, viscosity.

In CE6, all of the small sized non-spherical alumina is replaced by small sized spherical alumina (ce1a), thermal conductivity, viscosity and flowability of the composition are not qualified. The morphology of the filler non-spherical alumina (e1) partially impacts the testing results.

CE7 to CE11 comprise excess amount of small sized spherical alumina (ce1b), morphology and amount of the small sized filler impact the thermal conductivity.

In comparative examples CE13-CE14, the compositions comprise too much of the vinyl organopolysiloxane and the hydrogenated organopolysiloxane, too few fillers lead to good flowability but bad thermal conductivity.

In examples E18-E19, the compositions comprise somewhat less vinyl organopolysiloxane and the hydrogenated organopolysiloxane, which have qualified flowability and good thermal conductivity, but lead an increase in viscosity.

What is claimed is:

1. A thermal-conductive silicone potting composition comprising:
a component (A) comprising:
(a) a vinyl organopolysiloxane,
(c) a catalyst,
(e) a filler combination,
(f) an optional pigment,
a component (B) comprising:
(a) an optional vinyl organopolysiloxane,
(b) a hydrogenated organopolysiloxane,
(d) an optional inhibitor,
(e) a filler combination,
wherein the filler combination (e) includes:
e1) a non-spherical alumina having an average particle size D₅₀ of less than 3 μm,
e2) an alumina having an average particle size D₅₀ of 5 μm to 15 μm,
e3) a spherical alumina having an average particle size D₅₀ of 30 μm to 70 μm.

2. The thermal-conductive silicone potting composition of claim 1, wherein content of the filler combination (e) is from 91.0% to 94.5% by weight based on total weight of the thermal-conductive silicone potting composition.

3. The thermal-conductive silicone potting composition of claim 1, wherein the non-spherical alumina (e1) has an average particle size D₅₀ of 0.5-2.8 μm.

4. The thermal-conductive silicone potting composition of claim 1, wherein content of the non-spherical alumina (e1) is from 10% to 32% by weight based on the total weight of the thermal-conductive silicone potting composition.

5. The thermal-conductive silicone potting composition of claim 4, wherein the thermal-conductive silicone potting composition further comprises spherical alumina having an average particle size D₅₀ of less than 3 μm.

6. The thermal-conductive silicone potting composition of claim 4, wherein the thermal-conductive silicone potting composition further comprises a spherical alumina (ce1a) having an average particle size D₅₀ of less than 1 μm, present in an amount of less than 65% by weight, based on total weight of the spherical alumina (ce1a) and the non-spherical alumina (e1).

7. The thermal-conductive silicone potting composition of claim 4, wherein the thermal-conductive silicone potting composition further comprises a spherical alumina (ce1b) having an average particle size D₅₀ of 1-3 μm, present in an amount of less than 12% by weight, based on total weight of the spherical alumina (ce1b) and the non-spherical alumina (e1).

8. The thermal-conductive silicone potting composition of claim 1, wherein the alumina (e2) has an average particle size D₅₀ of 5-13 μm or 5-12 μm.

9. The thermal-conductive silicone potting composition of claim 1, wherein content of the alumina (e2) is from 3% to 10% by weight based on the total weight of the thermal-conductive silicone potting composition.

10. The thermal-conductive silicone potting composition of claim 1, wherein the spherical alumina (e3) has an average particle size D₅₀ of 40-70 μm.

11. The thermal-conductive silicone potting composition of claim 1, wherein content of the spherical alumina (e3) is from 50% to 65% by weight based on the total weight of the thermal-conductive silicone potting composition.

12. The thermal-conductive silicone potting composition of claim 1, wherein content of pigment (f) is from 0.01-0.05% by weight based on the total weight of the thermal-conductive silicone potting composition.

13. The thermal-conductive silicone potting composition of claim 1, wherein content of the vinyl organopolysiloxane and the hydrogenated organopolysiloxane is from 8.4% to 9.3% by weight based on the total weight of the thermal-conductive silicone potting composition.

14. A thermal conductive potting adhesive comprising the thermal-conductive silicone potting composition according to claim 1.

15. The thermal conductive potting adhesive of claim 14, wherein the thermal conductive potting adhesive has a thermal conductivity of equal to or greater than 2.88 W/(m·K) when subjected to ISO 22007-2 2022.

16. A method of protecting an electronic component from one or more of heat, contamination and vibration comprising encapsulating the electronic component in the thermal-conductive silicone potting composition according to claim 1.

17. An article potted using the thermal-conductive silicone potting composition according to claim 1.

18. An electronic component comprising the article of claim 17.

19. A battery module comprising an electric cell and a potting composition according to claim 1 associated with the electric cell.
